(19) United States
(12) Patent Application Publication
(10) Pub. No.: US 2007/0253437 A1
(43) Pub. Date: Nov. 1, 2007

(54) System and method for intelligent information handling system cluster switches

(76) Inventors: Ramesh Radhakrishnan, Austin, TX (US); Rinku Gupta, Austin, TX (US)

Correspondence Address: HAMILTON & TERRILE, LLP, P.O. BOX 203518, AUSTIN, TX, 78720, US

(21) Appl. No.: 11/414,406

(22) Filed: Apr. 28, 2006

(51) Int. Cl. H04L 12/56

(52) U.S. Cl. 370/401; 370/392

(57) ABSTRACT

Information is more efficiently distributed between master and slave information handling systems interfaced through a blocking network of switches by storing the information on switches within the blocking network and distributing the information from the switches. As an example, an application distribution module located on a leaf switch distributes an application, such as an operating system, to connected slave nodes so that the slave nodes do not have to retrieve the operating system from the master node through the blocking network. For instance, a PXE boot request from a slave node to the master node is intercepted at the leaf switch to allow the slave node to boot from an image of the operating system stored in local memory of the leaf switch.

### BACKGROUND OF THE INVENTION

1. Field of the Invention

The present invention relates in general to the field of information handling system clusters, and more particularly to a system and method for intelligent information handling system cluster switches.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Networking technology has greatly expanded the power of information handling systems. One example of this is the growing use of high performance computing clusters (HPCC) to perform calculation-intensive task as “supercomputers.” An HPCC is a cluster of hundreds or even thousands of information handling system nodes operating in a coordinated manner through a network. Typically, a master node supports a user node and a coordinating application that assigns tasks to the other slave nodes. As the slave nodes accomplish tasks, the results are communicated to the master node for further use. Each node operates as an independent information handling system subject to tasking by the master node with communication between the nodes sent through a series of switches typically arranged in a tree structure. Deployment of nodes to operate as a cluster is typically complex, sometimes taking days or even weeks to accomplish as each information handling system is configured to operate within the cluster with its own operating system. Once a cluster is up and running, frequent maintenance is often required to keep the cluster running smoothly, such as re-imaging hard disk drives on nodes or upgrading operating systems or applications on the nodes. In some instances, nodes are “diskless,” meaning that they lack a hard disk drive to permanently store an operating system. Diskless nodes can typically startup with a PXE boot (or any kind of network boot) to grab an image and boot from a storage system.

Although clusters provide a relatively inexpensive and flexible alternative to conventional supercomputing devices, a variety of difficulties tend to arise with the deployment, maintenance and use of information handling system clusters. One example of a difficulty is that large clusters tend to have lengthy deployment times depending upon the software tools and hardware infrastructure used. As an example, a single front end node often presents a bottleneck during deployment of software, especially where the front end node is servicing large numbers of slave nodes. For instance, during transfers of large quantities of information to large numbers of nodes, the network that interfaces the front end master node with the slave nodes sometimes becomes overwhelmed. A blocking network-boot fabric often presents a bottleneck if a number of nodes are simultaneously installing the operating system with a PXE boot through the front end node since the slave nodes obtain the operating system image over the network. Similarly, the network is sometimes overwhelmed during operating system maintenance, such as re-imaging nodes or installing updates. A typical cluster has a supporting network with a tree topology having the master node connected to a root switch and slave nodes connected to leaves. A tree topology aggravates network bottlenecks as cluster size increases. The relative impact of bottlenecks increases as network infrastructure speeds increase, such as by use of Infiniband or unified fabrics instead of Ethernet.

### SUMMARY OF THE INVENTION

Therefore a need has arisen for a system and method which reduces network bottlenecks related to operation of information handling system clusters.

In accordance with the present invention, a system and method are provided which substantially reduce the disadvantages and problems associated with previous methods and systems for managing information handling system cluster network communications. Information is stored on one or more switches to allow distribution of the information from the switch to information handling systems instead of from a restricted location, such as a master information handling system that manages plural slave information handling systems through the switch or switches.

More specifically, a switch having switching fabric to communication information between plural information handling systems also includes memory to store information repetitively communicated to information handling systems. An application distribution module running on the switch distributes the information stored on the switch to information handling systems to reduce the burden on a network interfacing the information handling systems. For instance, a high performance computing cluster having a master node, an interconnect fabric with plural levels of switches and plural slave information handling system nodes reduces start-up time by distributing an operating system to the slave nodes from one or more switches of the interconnect fabric, such as switches associated with a leaf node level of the interconnect fabric. PXE boot requests sent from slave nodes to the master node are intercepted by an application distribution module running on a switch. The application distribution module responds to slave node PXE boot requests by providing the operating system to the slave nodes from the switch memory. A mapping engine determines IP addresses for use by the slave nodes, such as within a range defined by the master node, and then provides the master node with the address information of the slave nodes.

The present invention provides a number of important technical advantages. One example of an important technical advantage is that distributing repeated operations that are network intensive from the front end node of a cluster to one or more switches of a cluster reduces bottlenecks at the front end. As an example, storing an operating system at a switch during deployment of the operating system to a slave node of the cluster allows the switch to deploy the operating system to its remaining nodes without burdening network communications at the front end node. Similarly, distributing operating system updates from the front node to the switch reduces the burden on front end node network communications during cluster-wide update deployments. Reduced network traffic at the front end of an information handling system cluster allows the front end node to more quickly and efficiently manage slave node operations.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of a high performance computing cluster of information handling systems;

FIG. 2 depicts a block diagram of a system for distributing applications to plural information handling systems from a switch; and

FIG. 3 depicts a flow diagram of a process for distributing an operating system application from a switch to plural information handling systems.

### DETAILED DESCRIPTION

Distributing an application from local memory of a switch to plural information handling systems reduces the risk that bottlenecks will form to slow a network at an information handling system tasked with managing distribution of the application. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

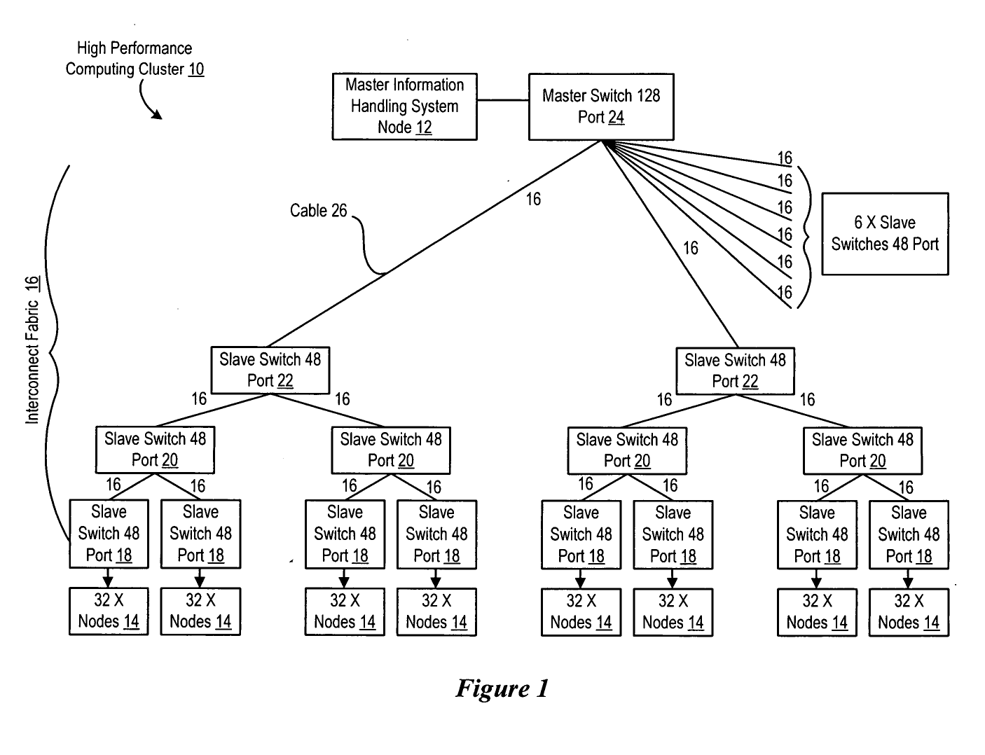

Referring now to FIG. 1, a block diagram depicts a high performance computing cluster 10 having a master information handling system node 12 and plural slave information handling system nodes 14. Master node 12 interfaces with slave nodes 14 through an interconnect fabric 16 having plural switches disposed in a tree architecture. In the example embodiment depicted by FIG. 1, a 1024 node cluster is depicted having 64 leaf switches 18 of 48 ports each that directly connect with the slave nodes 14. Leaf switches 18 connect with 32 second-level switches 20 having 48 ports each which, in turn, connect with 12 third-level switches 22 having 48 ports each. The third-level switches 22 connect with a master switch 24 having 128 ports and a connection with master node 12. Switches 18, 20, 22 and 24 connect with cables 26, such as Ethernet cables, Infiniband cables or cables that support a unified fabric in which a single fabric provides input and output communication, management and administration.

Master node 12 manages the operation of slave nodes 14 by communicating through interconnect fabric 16 to assign operations and retrieve results. Master node 12 provides slave nodes 14 with an operating system to support slave node operations and maintains the operating system, such as by distributing operating system updates to the slave nodes 14. For instance, at initial power-up of each slave node 14, master node 12 supports a PXE boot through interconnect fabric 16 to load an operating system on each slave node 14. If the slave nodes 14 do not have permanent storage, such as a hard disk drive, then each boot of a slave node 14 needs a copy of the operating system, which places a burden on interconnect fabric 16. For example, information transfers to support PXE boots form a bottleneck due to processing of the information at master node 12 or communication of the information through master switch 24. To avoid such bottlenecks, commonly communicated information, such as the operating system used in a PXE boot, is stored in interconnect fabric 16 for communication to nodes 14 without substantial impact on master node 12 or master switch 24. For instance, a copy of the operating system is stored on leaf switches 18 to use in support of a boot of slave nodes 14 that are connected to each leaf switch. In alternative embodiments, the operating system is stored on other slave switches, such as the second-level switches 20 or third-level switches 22. The information stored in interconnect fabric 16 may alternatively be applications other than the operating system or other information that is repetitively copied to slave nodes 14, such as an application to update the operating system.

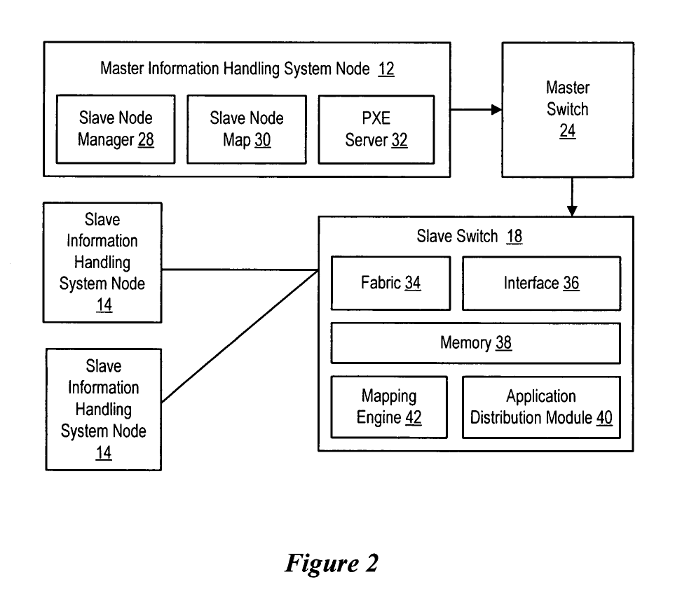

Referring now to FIG. 2, a block diagram depicts a system for distributing applications to plural information handling systems from a switch. Master information handling system node 12 includes a slave node manager 28 that manages operations performed on slave information handling system nodes 14, a slave node map 30 that tracks address information of slave nodes 14, such as IP and MAC addresses, and a PXE server 32 that responds to requests from slave nodes 14 to boot with an operating system stored at master node 12. Master node 12 communicates with slave node 14 through master switch 24 and one or more slave switches 18. Slave switch 18 includes a fabric 34 for switching information and an interface 36 that allows management of switch 18 from a distal location, such as master node 12. Interface 36 includes a toggle switch that directs switch 18 to switch information in a conventional manner or, if enabled, directs switch 18 to apply additional management features for distributing information from local memory 38 in switch 18 to slave nodes 14 connected or interfaced with switch 18.

Slave switch 18 includes an application distribution module 40 and mapping engine 42 that are enabled through interface 36 to provide intelligent distribution of information from memory 38 instead of having the information distributed from master node 12. Mapping engine 42 interfaces with slave node map 30 to retrieve IP address ranges for its associated slave nodes and to allow application distribution module 40 determine the number of switches and nodes connected to the switch and their the port addresses, as well as the number of uplinks connected to the switch and their port addresses. Alternatively, mapping engine 42 has logic to support assignment of DHCP addresses and to report the assigned addresses to master node 12. Application distribution module 40 manages the type and amount of information stored in memory 38, applies the network mapping information to determine nodes under its management, and manages the distribution of information from memory 38 to nodes under the direction of master node 12. As an example, application distribution module 40 has a PXE server that intercepts PXE boot requests from slave nodes 14 to master node 12 and that provides the operating system to slave nodes 14 to support the PXE boot in the place of master node 12. As another example, application distribution module 40 distributes operating system updates to all slave nodes 14 connected to it. Memory 38 may provide room to store plural operating systems or other applications so that application distribution module 40 distributes varied applications to different slave nodes 14 as directed by master node 12 through interface 36.

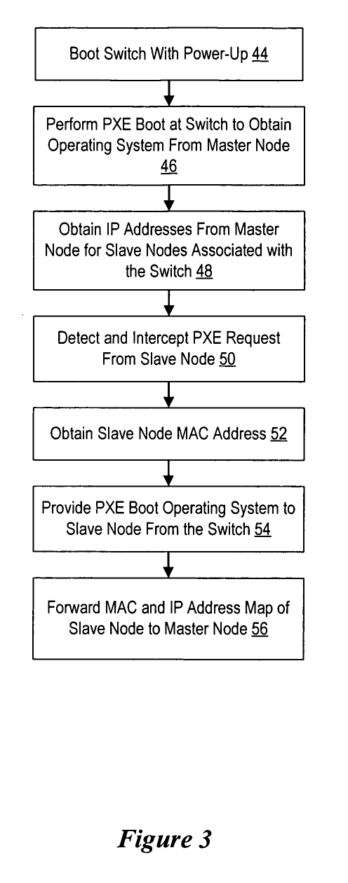

Referring now to FIG. 3, a flow diagram depicts a process for distributing an operating system application from a switch to plural information handling systems. The process begins at step 44 with boot of a switch at power-up of the switch. The process continues to step 46 for a PXE boot at the switch to obtain the operating system from the master node for use with the slave nodes. In an alternative embodiment, with the switch already powered-up, the operating system is instead copied at the switch during a conventional PXE boot of a slave node from the master node. Once the switch is powered up and has the operating system image, the process continues to step 48 at which the switch obtains IP addresses from the master node of the slave nodes associated with the switch, such as the slave nodes connected to the switch or interfaced with a down link port of the switch. At step 50, the switch monitors the slave nodes to detect and intercept requests by the slave nodes to PXE boot from the master node. At step 52, the switch obtains the MAC addresses from the NIC cards of the slave nodes so that, at step 54, the slave nodes may download the operating system from the switch node, such as by performing a PXE boot from the operating system image stored on the switch. As slave nodes boot from the switch, the MAC and IP addresses associated with each slave node are forwarded to the master node to support operation of cluster functions. An inexpensive yet efficient architecture to support distribution of the operating system or other applications from an interconnect fabric is to perform the distribution at each leaf node switch. Alternatively, buffer and flow control mechanisms allow distribution of applications form throughout the interconnect fabric by distributing the application at different switch levels.

Although the present invention has been described in detail, it should be understood that various changes, substitutions and alterations can be made hereto without departing from the spirit and scope of the invention as defined by the appended claims.

What is claimed is:

1. An information handling system comprising:
a master node operable to process information and to manage processing performed by plural slave nodes;
plural slave nodes operable to process information and to perform processing under the management of the master node;
an interconnect fabric operable to interface the master node and the slave nodes; and
an application distribution module disposed in the interconnect fabric, the application distribution module operable to supplement communications between the master node and slave nodes by storing information in the interconnect fabric.

2. The information handling system of claim 1 wherein the interconnect fabric comprises plural switches interfaced by a network in a tree structure having at least a master switch and plural leaf switches, the application distribution module embedded in each leaf switch.

3. The information handling system of claim 1 wherein the interconnect fabric comprises plural switches interfaced by a network, the application distribution module embedded in one or more switches.

4. The information handling system of claim 3 wherein the application comprises an operating system for operating the slave nodes, the application distribution module operable to intercept a slave node request for a PXE boot with the operating system from the master node and to provide the operating system to the slave node from memory located on the switch associated with the application distribution module.

5. The information handling system of claim 4 further comprising a mapping engine associated with the application distribution module, the mapping engine operable to obtain IP addresses from the master node and to assign the IP addresses to slave nodes at boot of each slave node.

6. The information handling system of claim 5 wherein the mapping engine is further operable to obtain MAC addresses from each slave node at boot of the slave node and to provide the MAC addresses to the master node.

7. The information handling system of claim 1 wherein the interconnect fabric comprises Ethernet.

8. The information handling system of claim 1 wherein the interconnect fabric comprises a unified fabric.

9. A method for distributing an application to plural information handling systems, the method comprising:
storing the application at a switch interfaced with the information handling systems;
requesting the application from the plural information handling systems; and
copying the application from the switch to the plural information handling systems in response to the requesting.

10. The method of claim 9 wherein storing the application at a switch further comprises:
detecting a PXE boot request from a slave information handling system to a master information handling system; and
copying the operating system that the master information handling system provides to the slave information handling system into local memory at the switch.

11. The method of claim 9 wherein storing the application at a switch comprises:
powering up the switch;
performing a PXE boot at the switch to obtain an operating system image for use by the plural information handling systems; and
storing the operating system into local memory at the switch accessible to support a PXE boot request for the operating system from the plural information handling systems.

12. The method of claim 9 wherein the application comprises an operating system update for operating systems running the plural information handling systems.

13. The method of claim 9 wherein requesting the application from the plural information handling systems further comprises:
issuing a PXE boot requests from the plural information handling systems to a master information handling system for an operating system; and
intercepting the PXE boot requests at the switch.

14. The method of claim 13 wherein copying the application from the switch further comprises responding to the PXE requests from the switch by providing the operating system from local memory of the switch.

15. The method of claim 14 further comprising:
requesting with the switch IP addresses from the master information handling system for use by the plural information handling systems;
applying the IP addresses with the switch to support the PXE requests of the plural information handling systems;
retrieving a MAC address from each of the plural information handling systems;
associating the applied IP addresses and MAC addresses to the plural information handling systems; and
providing the associated IP and MAC addresses to the master information handling system.

16. The method of claim 9 wherein the switch comprises one of plural switches disposed in a tree structure, the switch supporting plural information handling systems connected to it as leafs.

17. An information handling system switch comprising:
fabric operable to switch information communicated between plural information handling systems;
local memory operable to store information;
an application stored in the local memory; and
an application distribution module operable to distribute the application to plural information handling systems interfaced with the fabric.

18. The information handling system switch of claim 17 wherein the application comprises an operating system for use by plural information handling systems interfaced with the switch, the application distribution module further operable to support a boot by the plural information handling systems with the operating system.

19. The information handling system switch of claim 18 further comprising a mapping engine interfaced with the application distribution module, the mapping engine operable to retrieve plural IP addresses from a master information handling system, to assign the IP addresses to the plural information handling systems in support of the boot and to return the assigned IP addresses to the master information handling system.

20. The information handling system switch of claim 17 wherein the application further comprises an operating system update for use by plural information handling systems interfaced with the switch.
